(19) United States
(12) Patent Application Publication
(10) Pub. No.: US 2011/0083156 A1
(43) Pub. Date: Apr. 7, 2011

(54) NETWORK STREAMING OF A VIDEO STREAM OVER MULTIPLE COMMUNICATION CHANNELS

(75) Inventors: Martin Martinez, Ladera Ranch, CA (US); Eric Riggert, Lake Forest, CA (US)

(73) Assignee: CANON KABUSHIKI KAISHA, Tokyo (JP)

(21) Appl. No.: 12/575,428

(22) Filed: Oct. 7, 2009

(51) Int. Cl. H04N 7/173; H04N 7/12

(52) U.S. Cl. 725/118; 375/240.13; 375/E07.076

(57) ABSTRACT

The present disclosure is directed to streaming a video from a sending endpoint to a receiving endpoint. Both of the sending endpoint and the receiving endpoint have multiple communication channels connecting the sending endpoint and the receiving endpoint to one or more networks, respectively, and the streaming video includes a plurality of intra-frame coded frames and a plurality of inter-frame coded frames. The sending endpoint splits the video stream into the plurality of intra-frame coded frames and inter-frame coded frames. The sending endpoint then sends different ones of the plurality of intra-frame coded frames to the receiving endpoint over more than one of the multiple communication channels having a connection-oriented protocol. Also, the sending endpoint sends different ones of the plurality of inter-frame coded frames to the receiving endpoint over more than one of the multiple communication channels having a connectionless-oriented protocol. The sent intra-frame coded frames and inter-frame coded frames are then received and recombined at the receiving endpoint.

### BACKGROUND

1. Field

The present disclosure generally relates to video streaming, and more specifically relates to network video streaming from a sending endpoint to a receiving endpoint.

2. Description of the Related Art

In the field of video streaming, video streams may be sent from a sending side to a receiver side using a connectionless-oriented protocol, for example, a User Datagram Protocol (UDP). When using a connectionless-oriented protocol, there is no guarantee that all of the data of the video stream will be delivered to the receiver side, and there is no validation of the content of the data received at the receiver side. Therefore, there is a possibility that data may be lost when sent using a connectionless-oriented protocol. When specifically streaming video using a connectionless-oriented protocol, important reference frames (i.e., intra-frame coded frames) may be lost which may significantly affect the quality of the streaming video.

### SUMMARY

One solution to this problem is to send a video stream by using a connection-oriented protocol, such as Transmission Control Protocol (TCP). However, when sending a video stream using a connection-oriented protocol, delivery is guaranteed using a system of timeouts and retries, which makes the protocol more complex to process. The more complex processing with using a connection-oriented protocol may cause great delay in data delivery, which may lead to network congestion and degrade the quality of the video stream. Thus, using a connection-oriented protocol to stream a video stream may not always be viable.

In the present disclosure, the foregoing problems are addressed by streaming a video stream from a sending endpoint to a receiving endpoint, wherein both of the sending endpoint and the receiving endpoint have multiple communication channels connecting the sending endpoint and the receiving endpoint to one or more networks, respectively. The streamed video includes a plurality of intra-frame coded frames (such as I-frames) and a plurality of inter-frame coded frames (such as a plurality of P-frames and a plurality of B-frames). When streaming the video stream, different ones of the plurality of intra-frame coded frames are sent over more than one of the multiple communication channels having a connection-oriented protocol, and different ones of the plurality of inter-frame coded frames are sent over more than one of the multiple communication channels having a connectionless-oriented protocol.

Thus, in an example embodiment described herein, the sending endpoint splits the video stream into the plurality of intra-frame coded frames and the plurality of inter-frame coded frames. The sending endpoint then sends different ones of the plurality of intra-frame coded frames to the receiving endpoint over more than one of the multiple communication channels having a connection-oriented protocol, such as a Transmission Control Protocol (TCP). In this embodiment, the multiple communication channels may be carried over multiple physical interfaces connecting the sending endpoint and the receiving endpoint to multiple networks, respectively. In another embodiment, the multiple communication channels may be carried over a single physical interface. In addition, the sending endpoint sends different ones of the plurality of inter-frame coded frames to the receiving endpoint over more than one of the multiple communication channels having a connectionless-oriented protocol, such as a User Datagram Protocol (UDP). The sent intra-frame coded frames and inter-frame coded frames are then received at the receiving endpoint, and recombined to reconstruct the video stream.

By virtue of the foregoing arrangement, it is ordinarily possible to ensure delivery of important reference frames (i.e., intra-frame coded frames) of a streaming video, while reducing delay of the streaming video and congestion within a network, which in turn reduces any possible degradation of the quality of the video stream. More specifically, because different ones of the intra-frame coded frames of the streaming video are sent over more than one of multiple communication channels having a connection-oriented protocol, the intra-frame coded frames are more likely to be successfully delivered than if the intra-frame coded frames were sent over a connectionless-oriented protocol. Also, the intra-frame coded frames are delivered more quickly and with less delay since the intra-frame coded frames are sent over multiple communication channels. Furthermore, because different ones of less important frames (i.e., inter-frame coded frames) are sent over more than one of multiple communication channels having a connectionless-oriented protocol, any possible delay in streaming the video may be reduced because less data is sent using a connection-oriented protocol.

In addition, an advantageous effect may be obtained by virtue of the foregoing arrangement when there is asymmetry between a data capacity throughput upload speed on the sending endpoint and a data capacity throughput download speed on the receiving endpoint. More specifically, because both the intra-frame coded frames and the inter-frame coded frames are split and sent over more than one communication channel at the sending endpoint, it may be possible to provide a faster upload speed when the maximum upload speed is asymmetrically slower than the maximum download speed. Such asymmetry is common, for example, in asymmetric digital subscriber lines (ADSL) and cable. Such an advantage may be particularly evident in embodiments where the sending endpoint has multiple physical interfaces, since the speed of each individual interface is essentially accumulated into a larger effective speed.

In an example embodiment also described herein, when sending different ones of the plurality of intra-frame coded frames over more than one of the multiple communication channels, the intra-frame coded frames are sent in sequential order over sequentially selected ones of the multiple communication channels having a connection-oriented protocol in a round-robin fashion. Because different ones of the plurality of intra-frame coded frames are sent over more than one of the multiple communication channels having a connection-oriented protocol in a round-robin fashion, the data throughput of the intra-frame coded frames may be increased, while maintaining the reliability of using communication channels having a connection-oriented protocol.

In another example embodiment described herein, when sending different ones of the plurality of intra-frame coded frames over more than one of the multiple communication channels, an amount of intra-frame coded frames sent over each of the multiple communication channels is proportional to a data capacity throughput of each of the multiple communication channels compared to a total data capacity throughput of the multiple communication channels. For example, if a data capacity throughput of a first one of the multiple communication channels is 100 Mb/s, and a data capacity throughput of a second one of the multiple communication channels is 50 Mb/s, then roughly ⅔ of the intra-frame coded frames should be sent over the first communication channel, and roughly ⅓ of the intra-frame coded frames should be sent over the second communication channel. Because an amount of intra-frame coded frames sent over each of the multiple communication channels is proportional to a data capacity throughput of each of the multiple communication channels, the intra-frame coded frames may be delivered in an efficient manner by utilizing the difference in data throughput capacity of each of the multiple communication channels.

In yet another example embodiment described herein, when sending different ones of the plurality of intra-frame coded frames over more than one of the multiple communication channels, each of the plurality of intra-frame coded frames is split into multiple data packets, and different ones of the multiple data packets are sent over the multiple communication channels. In addition, in this example embodiment, an amount of the multiple data packets of the intra-frame coded frames sent over each of the multiple communication channels may be proportional to a data capacity throughput of each of the multiple communication channels compared to a total data capacity throughput of the multiple communication channels. Because each of the intra-frame coded frames is split into multiple data packets, and different ones of the multiple data packets are sent over multiple communication channels, the intra-frame coded frames may be delivered in an efficient manner by further utilizing the difference in data capacity throughput of each of the multiple communication channels. More specifically, the different data capacity throughputs of each of the multiple communication channels are further utilized because the size of data packets being sent is reduced, which in turn allows a more accurate apportionment of such data sent over a communication channel, based on a data capacity throughput of the communication channel.

In other example embodiments described herein, when sending the inter-frame coded frames over different ones of the multiple communication channels having a connectionless-oriented protocol, substantially similar embodiments as described above in connection with sending the intra-frame coded frames may be implemented. In addition, when sending the inter-frame coded frames, header information is attached to the inter-frame coded frames, which links the inter-frame coded frames to their respective intra-frame coded frames.

This brief summary has been provided so that the nature of the disclosure may be understood quickly. A more complete understanding can be obtained by reference to the following detailed description and to the attached drawings.

### BRIEF DESCRIPTION OF DRAWINGS

FIG. 1 is a representative view of a sending endpoint and a receiving endpoint, connected via multiple communication channels, on which an example embodiment may be implemented.

FIG. 2 is a representative view of a sending endpoint and a receiving endpoint, connected via multiple communication channels, on which another example embodiment may be implemented.

FIG. 3 is a detailed block diagram for explaining the internal architecture of the sending endpoint of FIGS. 1 and 2.

FIG. 4 is a detailed block diagram for explaining the internal architecture of the receiving endpoint of FIGS. 1 and 2.

FIG. 5 shows a typical example of a video stream.

FIG. 6 is a flowchart for providing a detailed explanation of an example embodiment.

FIG. 7 is a flowchart for further defining block 602 of FIG. 6.

FIG. 8 is a flowchart, according to an additional example embodiment, for further defining block 602 of FIG. 6.

FIG. 9 is a flowchart, according to another example embodiment, for further defining block 602 of FIG. 6.

FIG. 10 is a flowchart for further defining block 603 of FIG. 6.

FIG. 11 is a flowchart, according to yet another example embodiment, for further defining block 603 of FIG. 6.

FIG. 12 is a flowchart, according to an additional example embodiment, for further defining block 603 of FIG. 6.

FIG. 13 is a flowchart, according to another example embodiment, for further defining block 602 of FIG. 6.

FIG. 14 is a flowchart, according to yet another example embodiment, for further defining block 603 of FIG. 6.

### DETAILED DESCRIPTION

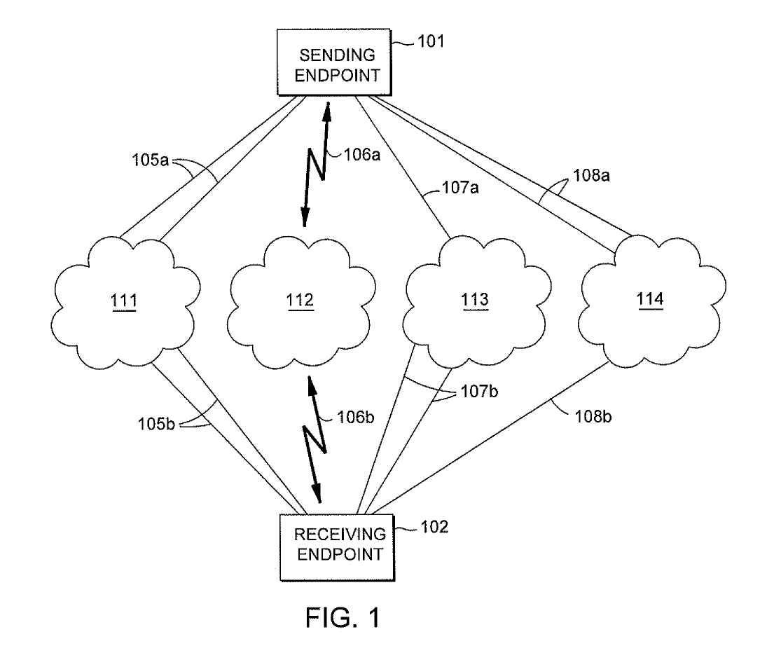

FIG. 1 is a representative view of a sending endpoint and a receiving endpoint, connected via multiple communication channels, on which an example embodiment may be implemented. As shown in FIG. 1, sending endpoint 101 is connected to receiving endpoint 102 through networks 111, 112, 113 and 114. The networks may include similar or dissimilar networks, mixed in any combination, as described below. Sending endpoint 101 includes multiple communication channels, including at least one or more communication channel for each different network. As shown in the example of FIG. 1, sending endpoint 101 includes communication channels 105a, 106a, 107a and 108a. More specifically, sending endpoint 101 has communication channels 105a which connect sending endpoint 101 to network 111. In FIG. 1, sending endpoint 101 is shown to have two communication channels 105a connecting to network 111; however, in other embodiments, sending endpoint 101 may have a single communication channel connecting to network 111, or may have more than two communication channels connecting to network 111.

Receiving endpoint 102 also has multiple communication channels 105b connecting to network 111. Similar to sending endpoint 101, receiving endpoint 102 may also have a single or multiple communication channels connecting to network 111. As a result of the communication channel connections, sending endpoint 101 is connected to receiving endpoint 102 through network 111, using communication channels 105b.

Similar to the above-described connection between sending endpoint 101 and receiving endpoint 102, sending endpoint 101 and receiving endpoint 102 are connected through networks 112, 113 and 114 via communication channels 106a and 106b, 107a and 107b and 108a and 108b. Accordingly, sending endpoint 101 is connected to network 112 through one or more communication channels 106a; and, receiving endpoint 102 is connected to network 112 through one or more communication channels 106b. Sending endpoint 101 is connected to network 113 through one or more communication channels 107a; and, receiving endpoint 102 is connected to network 113 through one or more communication channels 107b. Lastly, sending endpoint 101 is connected to network 114 through one or more communication channels 108a; and, receiving endpoint 102 is connected to network 114 through one or more communication channels 108b. In FIG. 1, sending endpoint 101 and receiving endpoint 102 are shown to be connected through four networks; however, sending endpoint 101 and receiving endpoint 102 may be connected through more or less networks. In this regard, the number of networks is established by a user's demands, or is established by an already existing infrastructure connecting the two endpoints.

Each of the communication channels can have either a connection-oriented protocol or a connectionless-oriented protocol. In this regard, a communication channel having a connection-oriented protocol is a communication channel which delivers a stream of data after first establishing a communication session. Examples of a connection-oriented protocol which may be used in this example embodiment include, but not limited to, Transmission Control Protocol (TCP), Datagram Congestion Control Protocol (DCCP), connection-oriented Ethernet, and Asynchronous Transfer Mode (ATM).

A communication channel having a connectionless-oriented protocol is a communication channel which transmits data from one endpoint to another endpoint, without first ensuring that the recipient is available and ready to receive the data. Examples of a connectionless-oriented protocol which may be used in this example embodiment include, but not limited to, User Datagram Protocol (UDP) and Internet Control Message Protocol (ICMP).

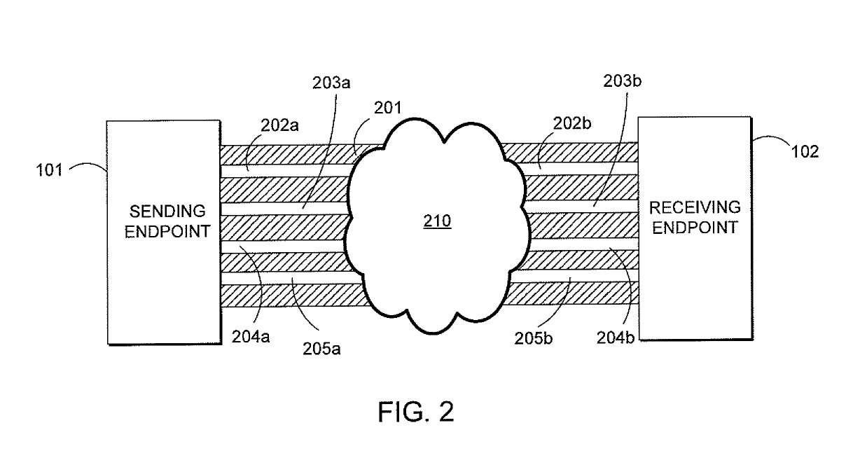

In the example embodiment shown in FIG. 1, the multiple communication channels are carried over multiple physical interfaces connecting the sending endpoint 101 and the receiving endpoint 102 to multiple networks 111 to 114, respectively. However, in another example embodiment, the multiple communication channels are carried over a single physical interface, which will be described in more detail below in connection with FIG. 2.

Networks 111, 112, 113 and 114, as shown in FIG. 1, can be many different types of networks, such as, for example, an Ethernet network, a Multimedia over Coax Alliance (MoCA) network, a HomePNA (Home Phoneline Networking Alliance) network, an Ethernet over powerline network (HomePlug), a wireless network, or any other type of network. In addition, the networks connecting the two endpoints can all be a different type of network (e.g., network 111 can be an Ethernet network, while network 112 is a wireless network, network 113 is an Ethernet over powerline network, and network 114 is a MoCA network). On the other hand, the networks connecting the two endpoints can include any variety of combinations of different networks (e.g., network 111 can be a MoCA network, while network 112 is a wireless network, and networks 113 and 114 are Ethernet networks). The type of physical interfaces connecting the endpoints to the networks depends upon the type of network. For example, an endpoint may be connected to an Ethernet network through twisted pair cable, an endpoint may be connected to a MoCA network through coaxial cable, an endpoint may be connected to an Ethernet over powerline network over power lines/wires, and an endpoint may be connected to a wireless network over one or more radio antennas.

The sending endpoint 101 serves as an application sender, such as a media server. A media server is an endpoint that will transfer audio and video data (or other types of large data) to a client. The media server may also be a modified third party application accessing the sending endpoint 101. For example, the media server can be a media center PC or a commercial web server that hosts media for a large web site. In this example embodiment, the media server can stream many different types of video, such as, for example, MPEG-1, MPEG-2, MPEG-3, MPEG-4 and AVI. In this regard, the streaming video is compressed video consisting of intra-frame coded frames and inter-frame coded frames.

The receiving endpoint 102 serves as an application receiver, such as a media client or media player. A media client or media player is an endpoint that receives data from a media server, and is used primarily for video and audio stream playing.

In some instances, a sending endpoint may also simultaneously act as a receiving endpoint. For example, when a sending endpoint serves as a video conferencing application, video would stream from the sending endpoint to the receiving endpoint, and video would stream simultaneously from the receiving endpoint to the sending endpoint. In this example, the sending endpoint would also be acting as a receiving endpoint, and the receiving endpoint would also be acting as a sending endpoint.

FIG. 2 is a representative view of a sending endpoint and a receiving endpoint, connected via multiple communication channels, on which another example embodiment may be implemented. More specifically, as shown in FIG. 2, sending endpoint 101 is connected to network 210 via a single physical interface 201. In addition, receiving endpoint 102 is connected to network 210 via the single physical interface 201. In this example embodiment, the single physical interface 201 includes communication channels 202a to 205a at the sending endpoint 101 and 202b to 205b at the receiving endpoint 102; however, in other embodiments, the single physical interface can include more than four communication channels.

In this embodiment, the connection over the single physical interface 201 includes a logical characteristic and a physical characteristic. The physical characteristic is a physical aspect on which the communication channels are carried, such as, for example, Ethernet (twisted cable), Wireless (802.11#), coax cable and fiber optic cable. In other words, the physical characteristic is the physical medium on which the communication channels travel upon, providing data to and from the endpoints. The logical characteristic is a segmentation of data via a port. In a simplistic illustrative example, consider the human communication method known as the postal service. In the postal service example, a piece of mail is sent by an individual from one household which contains four additional individuals. The individual may have sent the piece of mail to another household which contains six individuals. When the individual sends the mail via the postal service (a single medium), the postal service knows how to direct the mail to the post service closest to the intended receiver of the sent piece of mail. Once the mail has arrived at the intended receiver's household, it is provided to the appropriate individual. In this example, a single medium (the postal service) manages multiple data content and sends the data content to the correct receiver. In a more direct example, an Ethernet (e.g., twisted pair wire) can be used as a medium which uses multiple ports on which to connect the multiple communication channels between the sending endpoint and the receiving endpoint.

In addition, in this example embodiment, communication channels 202a, 202b, 203a and 203b have a connection-oriented protocol for sending data, and communication channels 204a, 204b, 205a and 205b have a connectionless-oriented protocol for sending data. Or, in another example embodiment, communication channels 202a, 202b, 203a and 203b have a connectionless-oriented protocol, and communication channels 204a, 204b, 205a and 205b have a connection-oriented protocol. In other embodiments which have more than four communication channels, a number of variations can exist in which each of the communication channels either has a connection-oriented protocol or a connectionless-oriented protocol, so long as at least two communication channels have a connection-oriented protocol and two communication channels have a connectionless-oriented protocol.

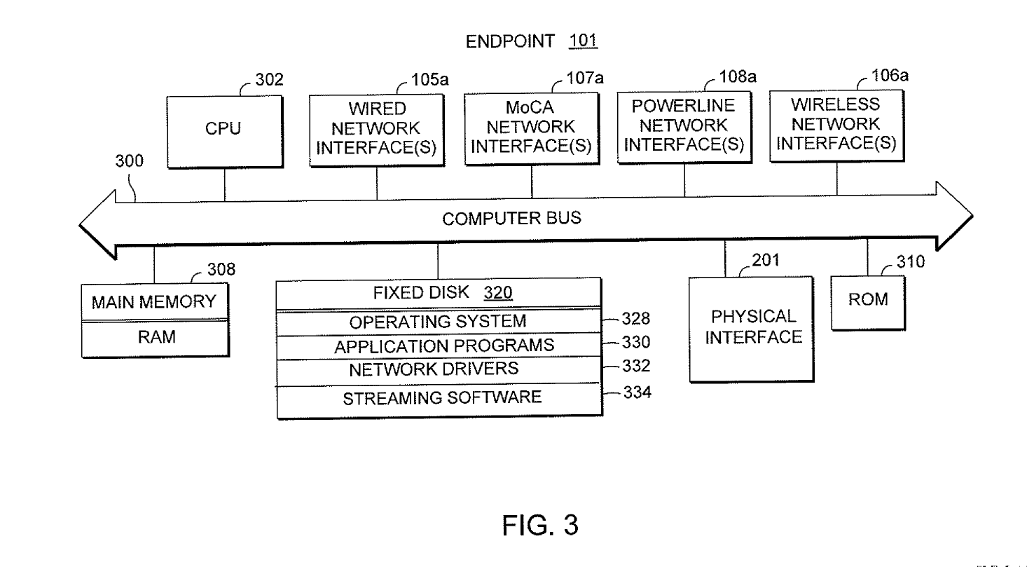

FIG. 3 is a detailed block diagram for explaining the internal architecture of the sending endpoint 101 of FIGS. 1 and 2. As shown in FIG. 3, sending endpoint 101 includes central processing unit (CPU) 302 which interfaces with computer bus 300. Also interfacing with computer bus 300 are hard (or fixed) disk 320, wired network interface(s) 105a, wireless network interface(s) 106a, MoCA network interface(s) 107a, powerline network interface(s) 108a, physical interface 201, random access memory (RAM) 308 for use as a main run-time transient memory, and read only memory (ROM) 310.

RAM 308 interfaces with computer bus 300 so as to provide information stored in RAM 308 to CPU 302 during execution of the instructions in software programs such as an operating system, application programs, and interface drivers. More specifically, CPU 302 first loads computer-executable process steps from fixed disk 320, or another storage device into a region of RAM 308. CPU 302 can then execute the stored process steps from RAM 308 in order to execute the loaded computer-executable process steps. In addition, data such as determined data capacity throughputs, gathered network performance statistics or other information can be stored in RAM 308, so that the data can be accessed by CPU 302 during the execution of computer-executable software programs, to the extent that such software programs have a need to access and/or modify the data.

As also shown in FIG. 3, hard disk 320 contains operating system 328, application programs 330 such as programs for starting up and shutting down the sending endpoint 101 or other programs, and streaming software 334. Hard disk 320 further contains network drivers 332 for software interface to networks such as networks 111, 112, 113 and 114.

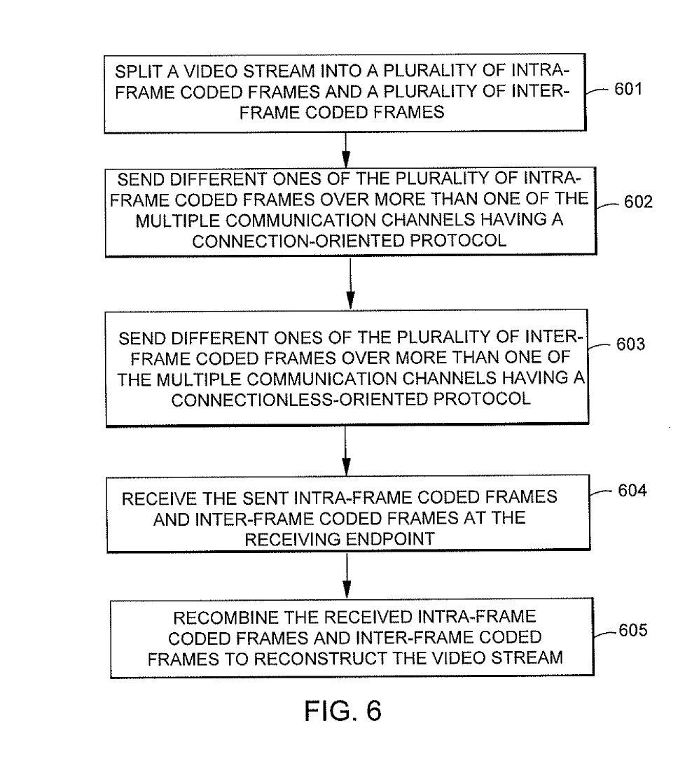

In an example embodiment, streaming software 334 is loaded by CPU 302 into a region of RAM 308. CPU 302 then executes the stored process steps included in the streaming software 334 as described in detail below in connection with FIGS. 6 to 14, in order to execute the loaded computer-executable steps.

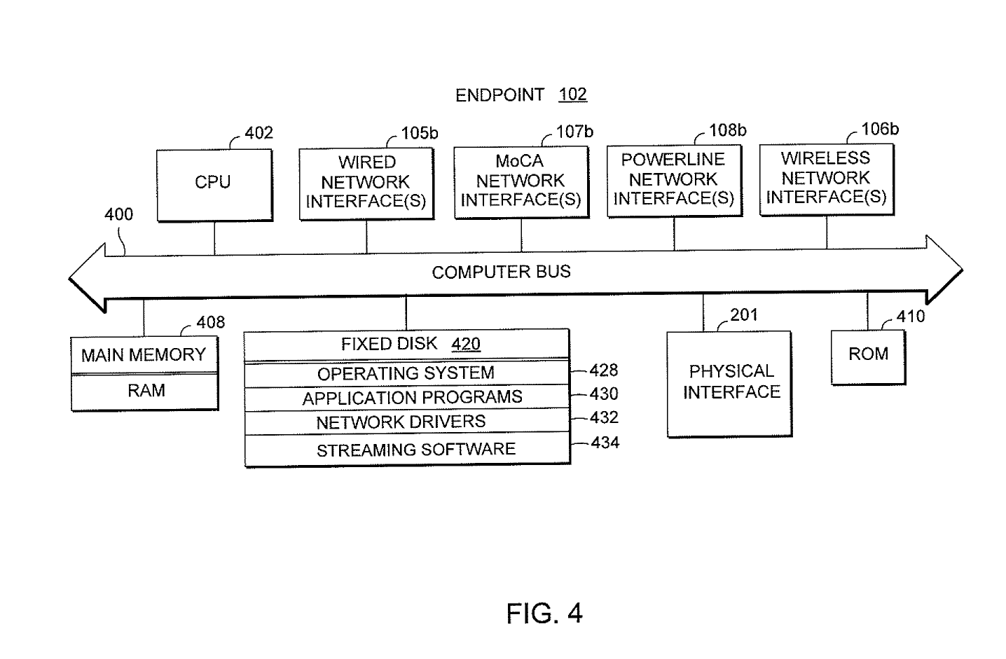

FIG. 4 is a detailed block diagram for explaining the internal architecture of the receiving endpoint 102 of FIGS. 1 and 2. As shown in FIG. 4, receiving endpoint 102 includes central processing unit (CPU) 402 which interfaces with computer bus 400. Also interfacing with computer bus 400 are hard (or fixed) disk 420, wired network interface(s) 105b, wireless network interface(s) 106b, MoCA network interface(s) 107b, powerline network interface(s) 108b, physical interface 201, random access memory (RAM) 408 for use as a main run-time transient memory, and read only memory (ROM) 410.

RAM 408 interfaces with computer bus 400 so as to provide information stored in RAM 408 to CPU 402 during execution of the instructions in software programs such as an operating system, application programs, and interface drivers. More specifically, CPU 402 first loads computer-executable process steps from fixed disk 420, or another storage device into a region of RAM 408. CPU 402 can then execute the stored process steps from RAM 408 in order to execute the loaded computer-executable process steps. In addition, data such as gathered network performance statistics or other information can be stored in RAM 408, so that the data can be accessed by CPU 402 during the execution of computer-executable software programs, to the extent that such software programs have a need to access and/or modify the data.

As also shown in FIG. 4, hard disk 420 contains operating system 428, application programs 430 such as programs for starting up and shutting down the receiving endpoint 102 or other programs, and streaming software 434.

The sending and receiving endpoints might implement different versions of the same software architecture. Or, the sending and receiving endpoints might implement architecture that target different operating systems, such as Windows on the sending endpoint and Linux on the receiving endpoint. Or, the sending endpoint and the receiving endpoint might implement architecture that is OS-neutral like JAVA. Lastly, hard disk 420 contains network drivers 432 for software interface to networks such as networks 111, 112, 113 and 114.

In an example embodiment, streaming software 434 is loaded by CPU 402 into a region of RAM 408. CPU 402 then executes the stored process steps included in the streaming software 434 as described in detail below in connection with FIGS. 6 to 14, in order to execute the loaded computer-executable steps.

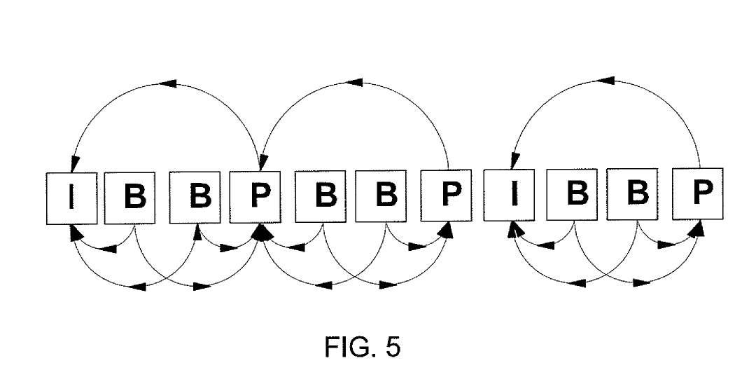

FIG. 5 shows a typical compressed video stream. As shown in FIG. 5, a typical video stream consists of intra-frame coded frames and inter-frame coded frames. In FIG. 5, the intra-frame coded frames are represented by “I” blocks, and the inter-frame coded frames are represented by “P” and “B” blocks. In this regard, I-frames are examples of intra-frame coded frames, which are key frames of the video stream. In addition, P-frames and B-frames are examples of inter-frame coded frames, which are less important than intra-frame coded frames. The example I-frames are encoded as a single image, with no reference to any past or future frames. The example P-frames are encoded relative to the past reference frame, which is the closest preceding of either an I-frame or a P-frame, as shown by the arrows in FIG. 5. The example B-frames are encoded relative to the past reference frame, the future reference frame, or both frames, as indicated by the arrows in FIG. 5. The future reference frame is the closest following reference frame which is either an I-frame or a P-frame.

FIG. 6 is a flowchart for providing a detailed explanation of this example embodiment. More specifically, FIG. 6 depicts a flowchart for providing a detailed explanation of an example embodiment, in which a video is streamed from a sending endpoint 101 to a receiving endpoint 102 (as shown in FIGS. 1 and 2). Both of the sending endpoint 101 and the receiving endpoint 102 each have multiple communication channels (105a and 105b to 108a and 108b of FIGS. 1 or 202a to 205a and 202b to 205b of FIG. 2) connecting the sending endpoint 101 and the receiving endpoint 102 to one or more networks, respectively. As described above in connection with FIGS. 1 and 2, in one example embodiment, the multiple communication channels are carried over multiple physical interfaces, or in another example embodiment, the multiple communication channels are carried over a single physical interface. In addition, as described above, the streaming video includes a plurality of intra-frame coded frames and a plurality of inter-frame coded frames.

As shown in FIG. 6, in block 601, the video stream is split into a plurality of intra-frame coded frames and a plurality of inter-frame coded frames. In this regard, the video stream is split into intra-frame coded frames and inter-frame coded frames in real-time (i.e., as the video is being streamed and just before the video stream is sent from the sending endpoint to the receiving endpoint). Each of the split intra-frame coded frames and inter-frame coded frames has header information which includes an original order of the frames, so that the receiving endpoint 102 can reconstruct the video stream in the proper order.

In this example embodiment, splitting, as defined herein, is based on dynamically changing network conditions, such as data capacity throughput, which may change due to network congestion or other traffic on the network (i.e., changing the amount of data sent to each communication channel) and upon content (i.e., sending the intra-frame coded frames to the communication channels which support connection-based sending). In addition, splitting includes the idea of sending data out of order to achieve or more closely approximate a correct reception order. In this regard, splitting, as used herein, should be distinguished from striping, which is usually used in conjunction with disk arrays, and is typically based specifically on fixed hardware characteristics of a system in question (e.g., striping includes bus design (sending bytes or bits to different devices) or RAID array configuration. In addition, striping usually involves dividing sequential data into sub-components and sending the sub-components simultaneously. Striping also often includes the concept of sending redundant or parity information to aid in recovery of corrupted data, which should not be confused with splitting as used herein.

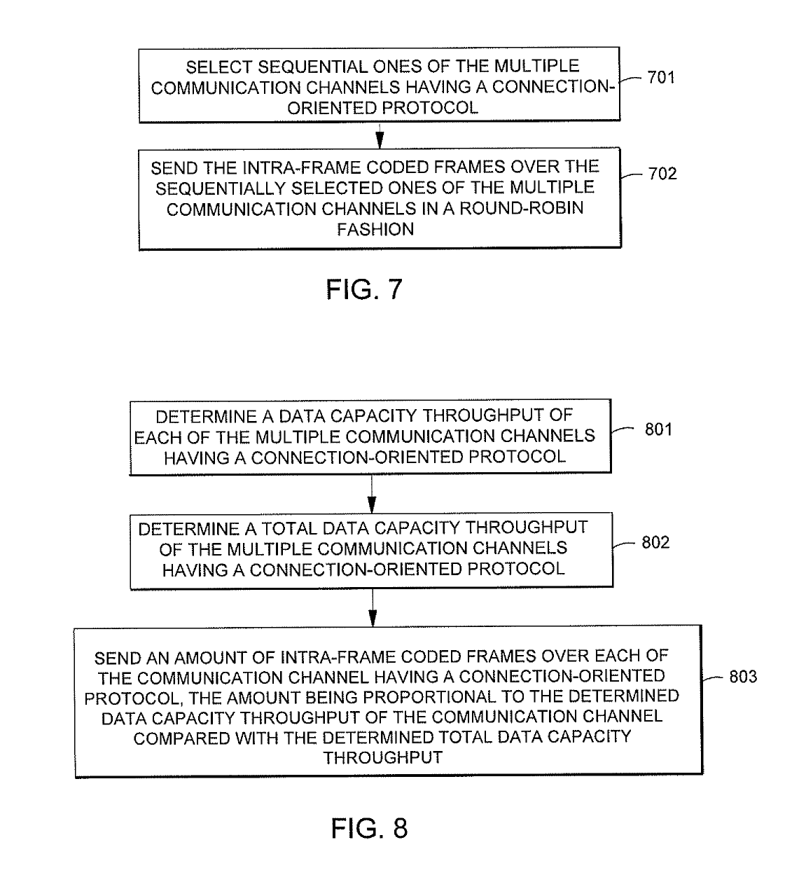

Different ones of the plurality of intra-frame coded frames are then sent, from the sending endpoint 101 to the receiving endpoint 102, over more than one of the multiple communication channels having a connection-oriented protocol (602). The plurality of intra-frame coded frames may be sent, for example, in a round-robin fashion, proportional to a data capacity throughput, or out of order. The step of sending different ones of the plurality of intra-frame coded frames over more than one of the multiple communication channels having a connection-oriented protocol is described in greater detail below in connection with FIGS. 7 to 9 and 13.

Different ones of the plurality of inter-frame coded frames are then sent, from the sending endpoint 101 to the receiving endpoint 102, over more than one of the multiple communication channels having a connectionless-oriented protocol (603). The plurality of inter-frame coded frames may be sent, for example, in a round-robin fashion, proportional to a data capacity throughput, or out of order. The step of sending different ones of the plurality of inter-frame coded frames over more than one of the multiple communication channels having a connectionless-oriented protocol is described in greater detail below in connection with FIGS. 10 to 12 and 14.

In block 604 of FIG. 6, the sent intra-frame coded frames and inter-frame coded frames are received at the receiving endpoint 102. The intra-frame coded frames and inter-frame coded frames received in block 604 are then recombined at the receiving endpoint 102 to reconstruct the video stream (605). In this regard, the receiving endpoint 102 uses the header information attached to each frame to reconstruct the video stream in the proper order.

By virtue of the foregoing embodiment, it is ordinarily possible to ensure delivery of important reference frames (i.e., intra-frame coded frames) of a streaming video, while reducing delay of the streaming video and congestion within a network, which in turn reduces any possible degradation of the quality of the video stream. More specifically, because different ones of the intra-frame coded frames of the streaming video are sent over more than one of multiple communication channels having a connection-oriented protocol, the intra-frame coded frames are more likely to be successfully delivered than if the intra-frame coded frames were sent over a connectionless-oriented protocol. Also, the intra-frame coded frames are delivered more quickly and with less delay since the intra-frame coded frames are sent over multiple communication channels. Furthermore, because different ones of less important frames (i.e., inter-frame coded frames) are sent over more than one of multiple communication channels having a connectionless-oriented protocol, any possible delay in streaming the video may be reduced because less data is sent using a connection-oriented protocol.

In addition, an advantageous effect may be obtained by virtue of the foregoing arrangement when there is asymmetry between a data capacity throughput upload speed on the sending endpoint and a data capacity throughput download speed on the receiving endpoint. More specifically, because both the intra-frame coded frames and the inter-frame coded frames are split and sent over more than one communication channel at the sending endpoint, it may be possible to provide a faster upload speed when the maximum upload speed is asymmetrically slower than the maximum download speed. Such asymmetry is common, for example, in asymmetric digital subscriber lines (ADSL) and cable. Such an advantage may be particularly evident in embodiments where the sending endpoint has multiple physical interfaces, since the speed of each individual interface is essentially accumulated into a larger effective speed.

FIG. 7 is a flowchart for further defining block 602 of FIG. 6 described above. As shown in FIG. 7, when sending the intra-frame coded frames from the sending endpoint 101 to the receiving endpoint 102, sequential ones of the multiple communication channels having a connection-oriented protocol are selected (701). The intra-frame coded frames are then sent over the sequentially selected ones of the multiple communication channels having a connection-oriented protocol in a round-robin fashion (702). For example, in FIG. 2, communication channel 202a having a connection-oriented protocol would be selected first, and communication channel 203a having a connection-oriented protocol would be selected second. Then, a first available intra-frame coded frame would be sent on communication channel 202a, a next available intra-frame coded frame would be sent on communication channel 203a, and a third available intra-frame coded frame would be sent on communication channel 202a, etc.

Because different ones of the plurality of intra-frame coded frames are sent over more than one of the multiple communication channels having a connection-oriented protocol in a round-robin fashion, the data throughput of the intra-frame coded frames may be increased, while maintaining the reliability of using communication channels having a connection-oriented protocol.

FIG. 8 is a flowchart, according to another example embodiment, for further defining block 602 of FIG. 6 described above. As shown in FIG. 8, when sending the intra-frame coded frames from the sending endpoint 101 to the receiving endpoint 102, a determination is made by the sending endpoint 101 as to a data capacity throughput of each of the multiple communication channels having a connection-oriented protocol (801). In this regard, the data capacity throughput for a communication channel is an amount of data throughput which is currently possible of being sent over the physical interface. Data capacity throughput is different from capacity. As an example, consider a case where a physical interface is connected to a network with a 100 Mbit network connection, the capacity of the physical interface is going to be 100 Mbps. However, in this same case, the data capacity throughput of the physical interface may be 40 Mbps due to, for example, other network traffic on the network.

A determination is then made by the sending endpoint 101 of a total data capacity throughput of the multiple communication channels having a connection-oriented protocol (802). This determination may be made, for example, by adding the determined data capacity throughputs of each of the communication channels having a connection-oriented protocol.

In block 803 of FIG. 8, an amount of intra-frame coded frames is sent, from the sending endpoint 101 to the receiving endpoint 102, over each of the communication channels having a connection-oriented protocol. The amount is proportional to the determined data capacity throughput of each communication channel having a connection-oriented protocol compared with the determined total data capacity throughput of the multiple communication channels having a connection-oriented protocol.

For example, if a data capacity throughput of a first one of the multiple communication channels is 100 Mb/s, and a data capacity throughput of a second one of the multiple communication channels is 50 Mb/s, then roughly ⅔ of the intra-frame coded frames should be sent over the first communication channel, and roughly ⅓ of the intra-frame coded frames should be sent over the second communication channel. In another example, the total data amount of intra-frame coded frames is 100 Kb, a data capacity throughput of a first one of the multiple communication channels is 100 Mb/s, and a data capacity throughput of a second one of the multiple communication channels is 50 Mb/s. In this example, then roughly 66.6 Kb of intra-frame coded frames should be sent over the first communication channel, and roughly 33.3 Kb of intra-frame coded frames should be sent over the second communication channel. Because an amount of intra-frame coded frames sent over each of the multiple communication channels is proportional to a data capacity throughput of each of the multiple communication channels, the intra-frame coded frames may be delivered in an efficient manner by utilizing the difference in data throughput capacity of each of the multiple communication channels.

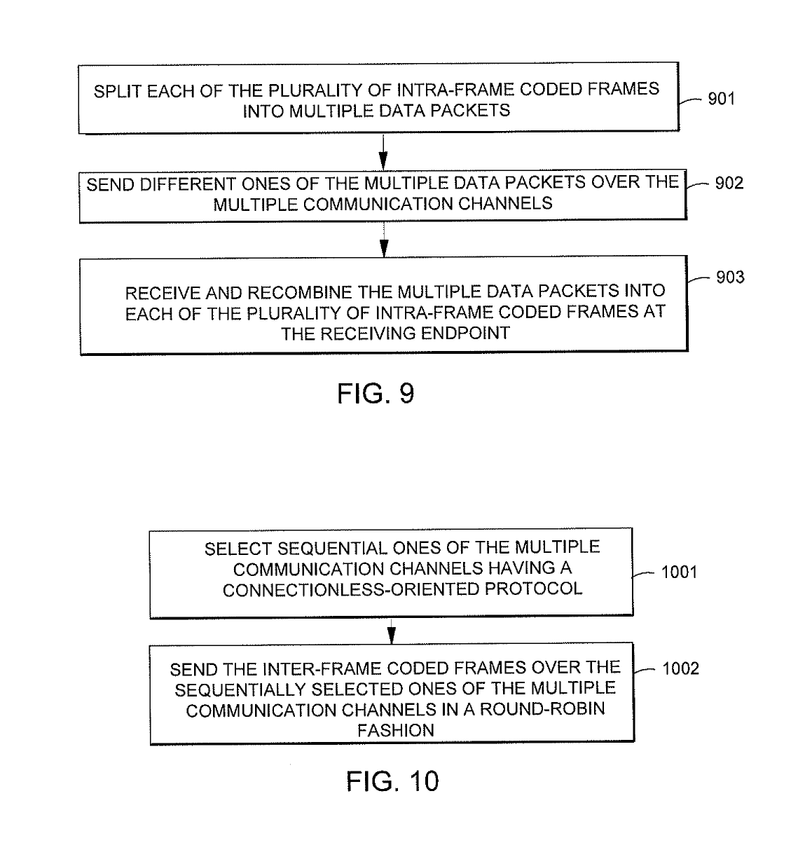

FIG. 9 is a flowchart, according to yet another example embodiment, for further defining block 602 of FIG. 6 described above. As depicted in FIG. 9, when sending intra-frame coded frames from the sending endpoint 101 to the receiving endpoint 102, each of the plurality of intra-frame coded frames is split into multiple data packets (901). Different ones of the multiple data packets are then sent over the multiple communication channels having a connection-oriented protocol (902). The multiple data packets are then received and recombined into each of the plurality of intra-frame coded frames at the receiving endpoint (903). Each of the multiple data packets has header information which includes an original order of the data packets for each split frame, to enable the receiving endpoint 102 to recombine the multiple data packets into the intra-frame coded frame.

Because each of the intra-frame coded frames is split into multiple data packets, and different ones of the multiple data packets are sent over multiple communication channels, the intra-frame coded frames may be delivered in an efficient manner by further utilizing the difference in data capacity throughput of each of the multiple communication channels. More specifically, the different data capacity throughputs of each of the multiple communication channels are further utilized because the size of data packets being sent is reduced, which in turn allows a more accurate apportionment of such data sent over a communication channel, based on a data capacity throughput of the communication channel.

FIG. 10 is a flowchart for further defining block 603 of FIG. 6 described above. As shown in FIG. 10, when sending the inter-frame coded frames from the sending endpoint 101 to the receiving endpoint 102, sequential ones of the multiple communication channels having a connectionless-oriented protocol are selected (1001). The inter-frame coded frames are then sent over the sequentially selected ones of the multiple communication channels having a connectionless-oriented protocol in a round-robin fashion (1002). Each of the inter-frame coded frames sent over the sequentially selected ones of the multiple communication channels has header information which associates the inter-frame coded frame with a particular intra-frame coded frame. In addition, the header information includes an order of the inter-frame coded frames as originally included in the video stream, so that the receiving endpoint 102 can preserve the order of the inter-frame coded frames. Because different ones of the plurality of inter-frame coded frames are sent over more than one of the multiple communication channels having a connectionless-oriented protocol in a round-robin fashion, the data throughput of the inter-frame coded frames may be increased.

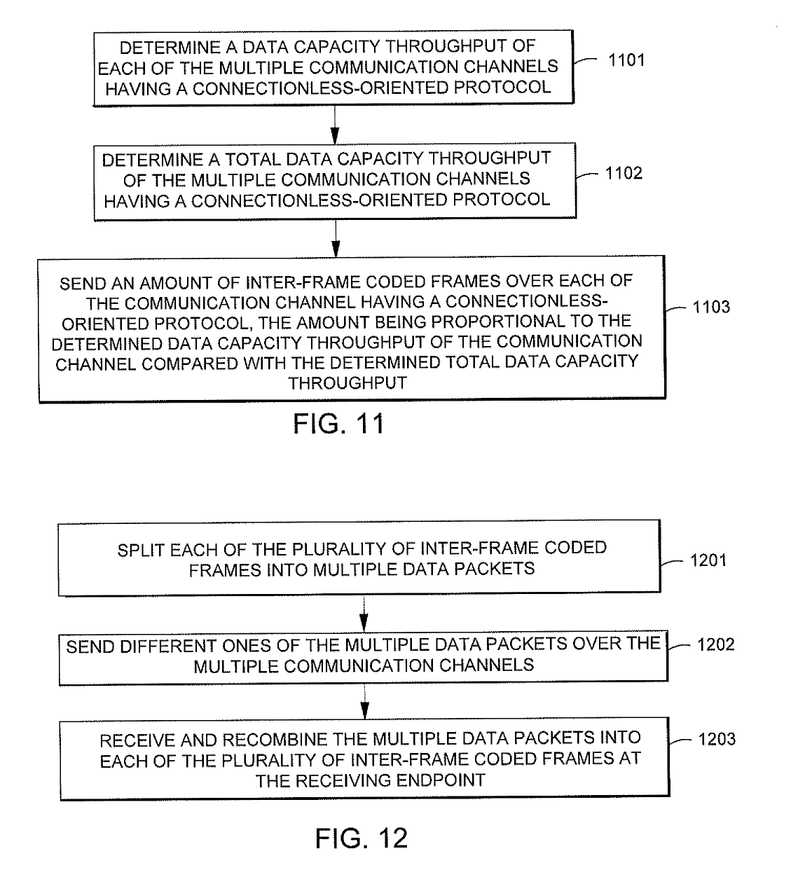

FIG. 11 is a flowchart, according to another example embodiment, for further defining block 603 of FIG. 6 described above. As depicted in FIG. 11, when sending the inter-frame coded frames from the sending endpoint 101 to the receiving endpoint 102, a determination is made by the sending endpoint 101 as to a data capacity throughput of each of the multiple communication channels having a connectionless-oriented protocol (1101). The determination made as to a data capacity throughput of each of the multiple communication channels having a connectionless-oriented protocol is substantially the same as the determination made as to a data capacity throughput of each of the multiple communication channels having a connection-oriented protocol, as described above in connection with FIG. 8.

A determination is then made by the sending endpoint 101 of a total data capacity throughput of the multiple communication channels having a connectionless-oriented protocol (1102). Again, this determination of the total data capacity throughput of the multiple communication channels having connectionless-oriented protocol is substantially the same as the determination made of a total data capacity throughput of the communication channels having a connection-oriented protocol, as described above in connection with FIG. 8.

In block 1103 of FIG. 11, an amount of inter-frame coded frames is sent, from the sending endpoint 101 to the receiving endpoint 102, over each of the communication channels having a connectionless-oriented protocol. The amount is proportional to the determined data capacity throughput of each communication channel having a connectionless-oriented protocol compared with the determined total data capacity throughput of the multiple communication channels having a connectionless-oriented protocol. Each of the inter-frame coded frames sent over the multiple communication channels has header information which associates the inter-frame coded frame with a particular intra-frame coded frame. In addition, the header information includes an order of the inter-frame coded frames as originally included in the video stream, so that the receiving endpoint 102 can preserve the order of the inter-frame coded frames. Because an amount of inter-frame coded frames sent over each of the multiple communication channels is proportional to a data capacity throughput of each of the multiple communication channels, the inter-frame coded frames may be delivered in an efficient manner by utilizing the difference in data throughput capacity of each of the multiple communication channels.

FIG. 12 is a flowchart, according to yet another example embodiment, for further defining block 603 of FIG. 6 described above. As shown in FIG. 12, each of the plurality of inter-frame coded frames is split into multiple data packets (1201). Different ones of the multiple data packets of the inter-frame coded frames are then sent, from the sending endpoint 101 to the receiving endpoint 102, over the multiple communication channels having a connectionless-oriented protocol (1202). The multiple data packets are then received and recombined into each of the plurality of inter-frame coded frames at the receiving endpoint (1203). Each of the multiple data packets has header information which includes an original order of the data packets for each split frame, to enable the receiving endpoint 102 to recombine the multiple data packets into the inter-frame coded frames. In addition, each of the split inter-frame coded frames has header information which includes an association to a specific intra-frame coded frame, and includes an order of the inter-frame coded frames as originally included in the video stream, so that the receiving endpoint 102 can preserve the order of the inter-frame coded frames.

Because each of the inter-frame coded frames is split into multiple data packets, and different ones of the multiple data packets are sent over multiple communication channels, the inter-frame coded frames may be delivered in an efficient manner by further utilizing the difference in data capacity throughput of each of the multiple communication channels. More specifically, the different data capacity throughputs of each of the multiple communication channels are further utilized because the size of data packets being sent is reduced, which in turn allows a more accurate apportionment of such data sent over a communication channel, based on a data capacity throughput of the communication channel.

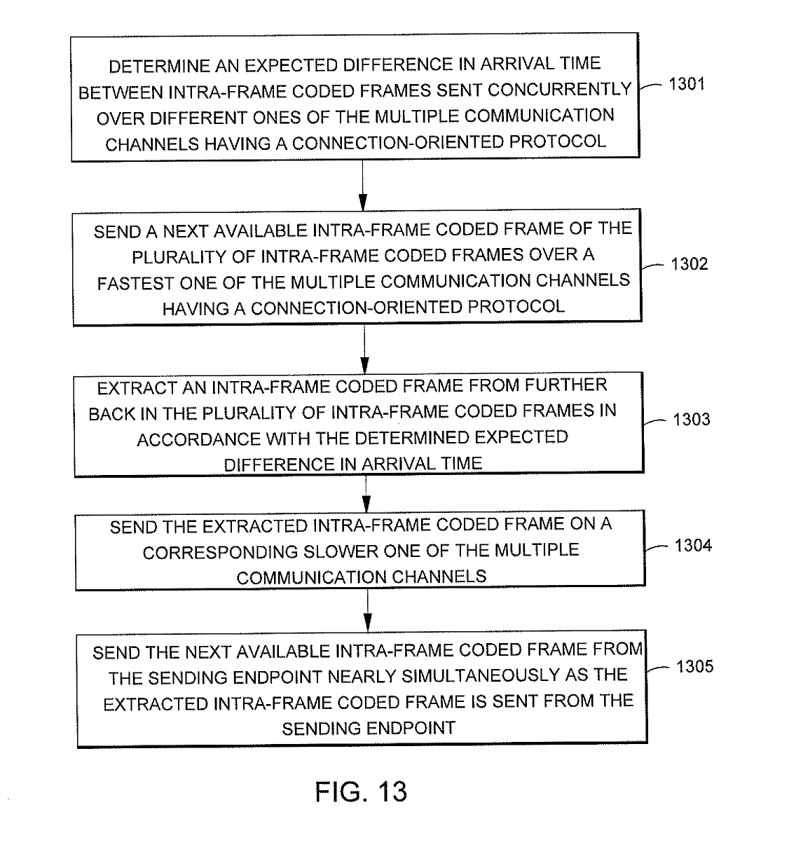

FIG. 13 is a flowchart, according to an additional example embodiment, for further defining block 602 of FIG. 6. In this example embodiment, the multiple communication channels which are used to send the data for intra-frame coded frames may all not be of equal performance (i.e., have different data capacity throughputs). Thus, in block 1301 of FIG. 13, a determination is made by the sending endpoint 101 as to an expected difference in arrival time between intra-frame coded frames sent concurrently over different ones of the multiple communication channels having a connection-oriented protocol. A next available intra-frame coded frame of the plurality of intra-frame coded frames is then sent, from the sending endpoint 101 to the receiving endpoint 102, over a fastest one of the multiple communication channels having a connection-oriented protocol (1302).

In block 1303, an intra-frame coded frame is extracted from further back in the plurality of intra-frame coded frames in accordance with the determined expected difference in arrival time. The extracted intra-frame coded frame is then sent, from the sending endpoint 101 to the receiving endpoint 102, on a corresponding slower one of the multiple communication channels having a connection-oriented protocol (1304). The next available intra-frame coded frame is then sent from the sending endpoint 101 nearly simultaneously as the extracted intra-frame coded frame is sent from the sending endpoint 101. A form of the process depicted in FIG. 13 is described in greater detail in U.S. patent application Ser. No. 12/463,367, “Network Streaming of a Single Data Stream Simultaneously Over Multiple Physical Interfaces”, the content of which is incorporated by reference herein.

By virtue of the foregoing arrangement, it is ordinarily possible to ensure that intra-frame coded frames of the video stream are received at a receiving endpoint on time and in approximate order, which in turn minimizes any unnecessary processing requirements at the receiving endpoint. In this regard, the receiving endpoint may be, for example, a typical set top box, digital video recorder (DVR), or other consumer device such as a consumer device intended for use with a TV. When compared with a typical desktop computer, laptop computer, or home server, the typical devices for a receiving endpoint are resource constrained having drastically less processing power, reduced memory, and smaller mass storage. However, the typical devices for the receiving endpoint will be tasked with, for example, receiving one or more streams of multimedia content, viewing and/or recording content from a cable or satellite TV provider, acting as an input/aggregation device for collecting pictures or uploading personal video content, purchasing and/or playing music, etc. In addition, in the above described arrangement of sending a single video stream over multiple communication channels, the receiving endpoint carries the additional burden of temporarily storing an unknown amount of data, and then reassembling the resulting data stream. Therefore, because intra-frame coded frames are extracted out of order from further back in the series, and these extracted intra-frame coded frames are sent over slower ones of the multiple physical interfaces so as to arrive in an approximate order of the original data stream, any unnecessary buffering and/or processing being performed by the receiving endpoint is minimized, which greatly reduces the load on an already overburdened receiving endpoint.

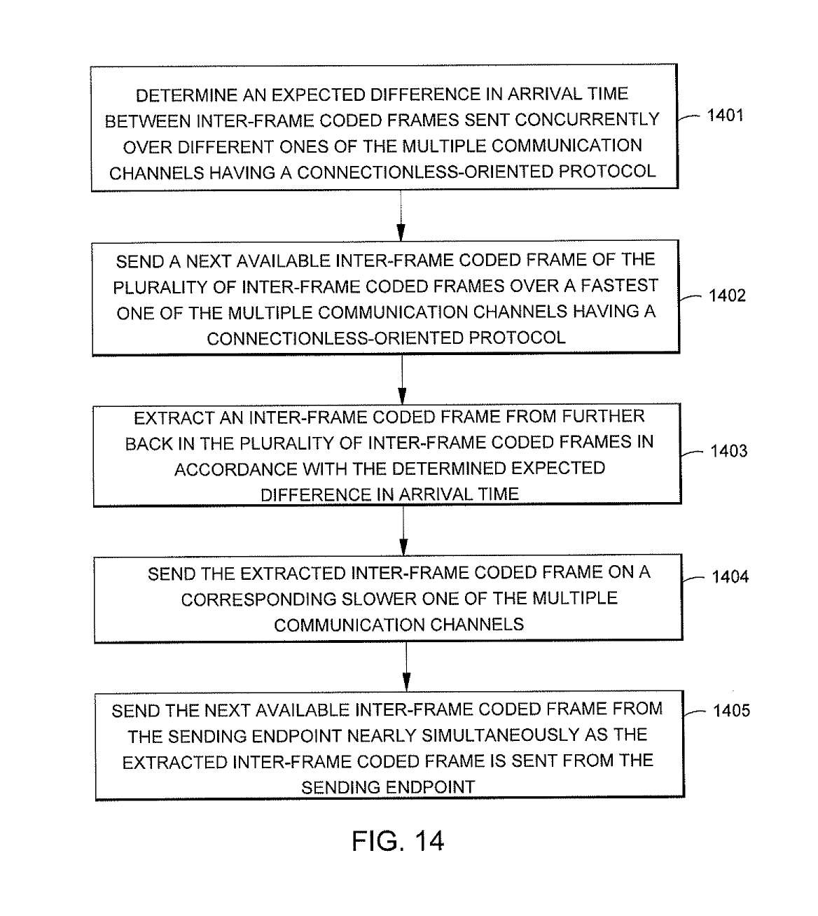

FIG. 14 is a flowchart, according to yet another example embodiment, for further defining block 603 of FIG. 6. In this example embodiment, the multiple communication channels which are used to send the data for inter-frame coded frames may all not be of equal performance (i.e., have different data capacity throughputs). Thus, in block 1401 of FIG. 14, a determination is made by the sending endpoint 101 as to an expected difference in arrival time inter-frame coded frames sent concurrently over different ones of the multiple communication channels having a connectionless-oriented protocol. A next available inter-frame coded frame of the plurality of inter-frame coded frames is then sent, from the sending endpoint 101 to the receiving endpoint 102, over a fastest one of the multiple communication channels having a connectionless-oriented protocol (1402).

In block 1403, an inter-frame coded frame is extracted from further back in the plurality of inter-frame coded frames in accordance with the determined expected difference in arrival time. The extracted inter-frame coded frame is then sent, from the sending endpoint 101 to the receiving endpoint 102, on a corresponding slower one of the multiple communication channels having a connectionless-oriented protocol (1404). The next available inter-frame coded frame is then sent from the sending endpoint 101 nearly simultaneously as the extracted inter-frame coded frame is sent from the sending endpoint 101. A form of the process depicted in FIG. 14 is described in greater detail in U.S. patent application Ser. No. 12/463,367, “Network Streaming of a Single Data Stream Simultaneously Over Multiple Physical Interfaces”, the content of which is incorporated by reference herein.

This disclosure has provided a detailed description with respect to particular illustrative embodiments. It is understood that the scope of the appended claims is not limited to the above-described embodiments and that various changes and modifications may be made by those skilled in the relevant art without departing from the scope of the claims.

What is claimed is:

1. A method for streaming a video from a sending endpoint to a receiving endpoint, wherein both of the sending endpoint and the receiving endpoint have multiple communication channels connecting the sending endpoint and the receiving endpoint to one or more networks, respectively, wherein the streaming video includes a plurality of intra-frame coded frames and a plurality of inter-frame coded frames, and wherein in said method the sending endpoint performs the steps of:
splitting the video stream into the plurality of intra-frame coded frames and the plurality of inter-frame coded frames;
sending different ones of the plurality of intra-frame coded frames over more than one of the multiple communication channels having a connection-oriented protocol; and
sending different ones of the plurality of inter-frame coded frames over more than one of the multiple communication channels having a connectionless-oriented protocol, wherein the sent intra-frame coded frames and inter-frame coded frames are received at the receiving endpoint, and recombined to reconstruct the video stream.

2. The method according to claim 1, wherein in the step of sending different ones of the plurality of intra-frame coded frames over more than one of the multiple communication channels, the intra-frame coded frames are sent in sequential order over sequentially selected ones of the multiple communication channels having a connection-oriented protocol in a round-robin fashion.

3. The method according to claim 1, wherein in the step of sending different ones of the plurality of intra-frame coded frames over more than one of the multiple communication channels, an amount of intra-frame coded frames sent over each of the multiple communication channels is proportional to a data capacity throughput of each of the multiple communication channels compared to a total data capacity throughput of the multiple communication channels.

4. The method according to claim 1, wherein in the step of sending different ones of the plurality of intra-frame coded frames over more than one of the multiple communication channels, each of the plurality of intra-frame coded frames is split into multiple data packets, and different ones of the multiple data packets are sent over the multiple communication channels.

5. The method according to claim 4, wherein an amount of the multiple data packets of the intra-frame coded frames sent over each of the multiple communication channels is proportional to a data capacity throughput of each of the multiple communication channels compared to a total data capacity throughput of the multiple communication channels.

6. The method according to claim 1, wherein in the step of sending different ones of the plurality of inter-frame coded frames over more than one of the multiple communication channels, the inter-frame coded frames are sent in sequential order over sequentially selected ones of the multiple communication channels having a connectionless-oriented protocol in a round-robin fashion.

7. The method according to claim 1, wherein in the step of sending different ones of the plurality of inter-frame coded frames over more than one of the multiple communication channels, an amount of inter-frame coded frames sent over each of the multiple communication channels is proportional to a data capacity throughput of each of the multiple communication channels.

8. The method according to claim 1, wherein in the step of sending different ones of the plurality of inter-frame coded frames over more than one of the multiple communication channels, each of the plurality of inter-frame coded frames are split into multiple data packets, and different ones of the multiple data packets are sent over the multiple communication channels.

9. The method according to claim 8, wherein an amount of the multiple data packets of the inter-frame coded frames sent over each of the multiple communication channels is proportional to a data capacity throughput of each of the multiple communication channels compared to a total data capacity throughput of the multiple communication channels.

10. The method according to claim 1, wherein the multiple communication channels are carried over multiple physical interfaces connecting the sending endpoint and the receiving endpoint to multiple networks, respectively.

11. The method according to claim 1, wherein the multiple communication channels are carried over a single physical interface.

12. The method according to claim 1, wherein a determination is made as to an expected difference in arrival time between intra-frame coded frames sent concurrently over different ones of the multiple communication channels having a connection-oriented protocol, and an expected difference in arrival time between inter-frame coded frames sent concurrently over different ones of the multiple communication channels having a connectionless-oriented protocol,
wherein in said step of sending the intra-frame coded frames, a next available intra-frame coded frame of the plurality of intra-frame coded frames is sent over a fastest one of the multiple communication channels having a connection-oriented protocol, the fastest one of the multiple communication channels being determined based on the determined expected difference in arrival time,
wherein an intra-frame coded frame is extracted from further back in the plurality of intra-frame coded frames in accordance with the determined expected difference in arrival time, and the extracted intra-frame coded frame is sent on a corresponding slower one of the multiple communication channels,
wherein the next available intra-frame coded frame is sent from the sending endpoint nearly simultaneously as the extracted intra-frame coded frame is sent from the sending endpoint,
wherein in said step of sending the inter-frame coded frames, a next inter-frame coded frame of the plurality of inter-frame coded frames is sent over a fastest one of the multiple communication channels having a connectionless-oriented protocol, the fastest one of the multiple communication channels being determined based on the determined expected difference in arrival time,
wherein a inter-frame coded frame is extracted from further back in the plurality of inter-frame coded frames in accordance with the determined expected difference in arrival time, and the extracted inter-frame coded frame is sent on a corresponding slower one of the multiple communication channels, and
wherein the next available inter-frame coded frame is sent from the sending endpoint nearly simultaneously as the extracted inter-frame coded frame is sent from the sending endpoint.

13. A method for streaming a video from a sending endpoint to a receiving endpoint, wherein both of the sending endpoint and the receiving endpoint have multiple communication channels connecting the sending endpoint and the receiving endpoint to one or more networks, respectively, wherein the streaming video includes a plurality of intra-frame coded frames and a plurality of inter-frame coded frames, and wherein in said method the receiving endpoint performs the steps of:
receiving intra-frame coded frames and inter-frame coded frames sent from the sending endpoint; and
recombining the intra-frame coded frames and inter-frame coded frames to reconstruct the video stream,
wherein the video stream is split by the sending endpoint into the plurality of intra-frame coded frames and the plurality of inter-frame coded frames, different ones of the plurality of intra-frame coded frames are sent over more than one of the multiple communication channels having a connection-oriented protocol, and different ones of the plurality of inter-frame coded frames are sent over more than one of the multiple communication channels having a connectionless-oriented protocol.

14. A method for streaming a video from a sending endpoint to a receiving endpoint, wherein both of the sending endpoint and the receiving endpoint have multiple communication channels connecting the sending endpoint and the receiving endpoint to one or more networks, respectively, wherein the streaming video includes a plurality of intra-frame coded frames and a plurality of inter-frame coded frames, and wherein said method comprises:
splitting at the sending endpoint the video stream into the plurality of intra-frame coded frames and the plurality of inter-frame coded frames;
sending from the sending endpoint to the receiving endpoint different ones of the plurality of intra-frame coded frames over more than one of the multiple communication channels having a connection-oriented protocol; and
sending from the sending endpoint to the receiving endpoint different ones of the plurality of inter-frame coded frames over more than one of the multiple communication channels having a connectionless-oriented protocol;
receiving the sent intra-frame coded frames and inter-frame coded frames at the receiving endpoint; and
recombining the received intra-frame coded frames and inter-frame coded frames to reconstruct the video stream.

15. A sending endpoint comprising:
a computer-readable memory constructed to store computer-executable process steps; and
a processor constructed to execute the computer-executable steps stored in the memory,
wherein the process steps stored in the memory cause the processor to stream a video from the sending endpoint to a receiving endpoint, wherein both of the sending endpoint and the receiving endpoint have multiple communication channels connecting the sending endpoint and the receiving endpoint to one or more networks, respectively, wherein the streaming video includes a plurality of intra-frame coded frames and a plurality of inter-frame coded frames, and wherein the process steps stored in the memory include computer-executable process steps to:
split the video stream into the plurality of intra-frame coded frames and the plurality of inter-frame coded frames;
send different ones of the plurality of intra-frame coded frames over more than one of the multiple communication channels having a connection-oriented protocol; and
send different ones of the plurality of inter-frame coded frames over more than one of the multiple communication channels having a connectionless-oriented protocol,
wherein the sent intra-frame coded frames and inter-frame coded frames are received at the receiving endpoint, and recombined to reconstruct the video stream.

16. A receiving endpoint comprising:
a computer-readable memory constructed to store computer-executable process steps; and
a processor constructed to execute the computer-executable steps stored in the memory,
wherein the process steps stored in the memory cause the processor to stream a video from a sending endpoint to the receiving endpoint, wherein both of the sending endpoint and the receiving endpoint have multiple communication channels connecting the sending endpoint and the receiving endpoint to one or more networks, respectively, wherein the streaming video includes a plurality of intra-frame coded frames and a plurality of inter-frame coded frames, and wherein the process steps stored in the memory include computer-executable process steps to:
receive intra-frame coded frames and inter-frame coded frames sent from the sending endpoint; and
recombine the intra-frame coded frames and inter-frame coded frames to reconstruct the video stream,
wherein the video stream is split by the sending endpoint into the plurality of intra-frame coded frames and the plurality of inter-frame coded frames, different ones of the plurality of intra-frame coded frames are sent over more than one of the multiple communication channels having a connection-oriented protocol, and different ones of the plurality of inter-frame coded frames are sent over more than one of the multiple communication channels having a connectionless-oriented protocol.

17. A computer-readable memory medium on which is stored computer-executable process steps for causing a processor to streaming a video from a sending endpoint to a receiving endpoint, wherein both of the sending endpoint and the receiving endpoint have multiple communication channels connecting the sending endpoint and the receiving endpoint to one or more networks, respectively, wherein the streaming video includes a plurality of intra-frame coded frames and a plurality of inter-frame coded frames, said processing steps comprising:
splitting the video stream into the plurality of intra-frame coded frames and the plurality of inter-frame coded frames;
sending different ones of the plurality of intra-frame coded frames over more than one of the multiple communication channels having a connection-oriented protocol; and
sending different ones of the plurality of inter-frame coded frames over more than one of the multiple communication channels having a connectionless-oriented protocol,
wherein the sent intra-frame coded frames and inter-frame coded frames are received at the receiving endpoint, and recombined to reconstruct the video stream.

18. A computer-readable memory medium on which is stored computer-executable process steps for causing a processor to streaming a video from a sending endpoint to a receiving endpoint, wherein both of the sending endpoint and the receiving endpoint have multiple communication channels connecting the sending endpoint and the receiving endpoint to one or more networks, respectively, wherein the streaming video includes a plurality of intra-frame coded frames and a plurality of inter-frame coded frames, said processing steps comprising:
receiving intra-frame coded frames and inter-frame coded frames sent from the sending endpoint; and
recombining the intra-frame coded frames and inter-frame coded frames to reconstruct the video stream,
wherein the video stream is split by the sending endpoint into the plurality of intra-frame coded frames, the plurality of inter-frame coded frames, different ones of the plurality of intra-frame coded frames are sent over more than one of the multiple communication channels having a connection-oriented protocol, and different ones of the plurality of inter-frame coded frames are sent over more than one of the multiple communication channels having a connectionless-oriented protocol.
